(19) United States
(12) Patent Application Publication
(10) Pub. No.: US 2006/0136349 A1
(43) Pub. Date: Jun. 22, 2006

(54) System and method for statistical aggregation of data

(76) Inventor: Alexander Craig Filshie Russell, (US)

Correspondence Address: IBM CORPORATION, 3039 CORNWALLIS RD., DEPT. T81 / B503, PO BOX 12195, REASEARCH TRIANGLE PARK, NC, 27709, US

(21) Appl. No.: 11/290,088

(22) Filed: Nov. 30, 2005

(30) Foreign Application Priority Data
Dec. 22, 2004 (GB) 0428037.6

(51) Int. Cl. G06N 5/00

(52) U.S. Cl. 706/45

(57) ABSTRACT

A system and method for statistical aggregation and posthumous inclusion of extreme data by analyzing a data sample to determine whether it lies within or outside a predetermined range; aggregating the data sample into a summary if the data sample is determined to lie within the predetermined range; and recording the data sample, together with at least one related parameter, if the data sample is determined to lie outside the predetermined range.

### FIELD OF THE INVENTION

This invention relates to measurement and analysis of data, and particularly, although not exclusively, to measurement and analysis of computer generated data.

### BACKGROUND

The measurement and analysis of data such as computer generated data often requires the retention of massive amounts of data, and an associated resource cost on the computer being used for the analysis. There are well understood techniques, such as statistical distribution analysis, exponential smoothing, and the like, available to aggregate the samples collected and represent them using coefficients. These permit a running summary to be presented without the need to retain each individual sample. When there are hundreds of thousands or millions of individual samples, using aggregation may be the only realistic way forward, although there is a disadvantage with any aggregation approach in that the summary technique chosen must be selected before any samples are collected, and the samples may not be best represented by the chosen technique.

Whether aggregation is applied or not, as samples are collected they can be compared to the current set of data, and a calculation made to determine whether or not each new sample is extreme, i.e., whether the sample falls outside or inside of the boundaries imposed by a chosen statistical distribution. Either the boundaries are determined ahead of time before sampling begins, or are derived after an initial number of samples have been collected which are deemed as representative of the sample population. If the new sample falls outside of the boundaries it is dubbed an ‘outlier’. In this case, the sample is typically either simply highlighted as an ‘outlier’ and incorporated into the sample set, or more usually it is discarded, since it has been dubbed to fall at the extreme of the sample population.

Known techniques for selective querying using outlier indexing and weighting to minimize the effect of outliers causing skew are described in the publications “Overcoming Limitations of Sampling for Aggregation Queries” by Chaudhuri et al., Proceedings of 17th International Conference on Data Engineering, Heidelberg, Germany 2001; “A Robust, Optimization-Based Approach for Approximate Answering of Aggregate Queries” by Chaudhuri et al., Microsoft Research Technical Report MSR-TR-2001-37, April 2001; and patent publications US22123979A1, US22124001A1 and WOO4006072A2. However, these known techniques have the disadvantage of being inefficient in their use/non-use of outlier data for aggregation, and can compromise the usefulness of data aggregation.

### SUMMARY

In accordance with a first aspect of the present invention, there is provided a system for statistical aggregation of data. The system includes means for analyzing a data sample to determine whether it lies within or outside a predetermined range; means for aggregating the data sample into a summary if the data sample is determined to lie within the predetermined range; and means for recording the data sample, together with at least one related parameter, if the data sample is determined to lie outside the predetermined range.

In accordance with a second aspect of the present invention, there is provided a method for statistical aggregation of data. The method includes analyzing a data sample to determine whether it lies within or outside a predetermined range; aggregating the data sample into a summary if the data sample is determined to lie within the predetermined range; and recording the data sample, together with at least one related parameter, if the data sample is determined to lie outside the predetermined range.

### BRIEF DESCRIPTION OF THE DRAWING

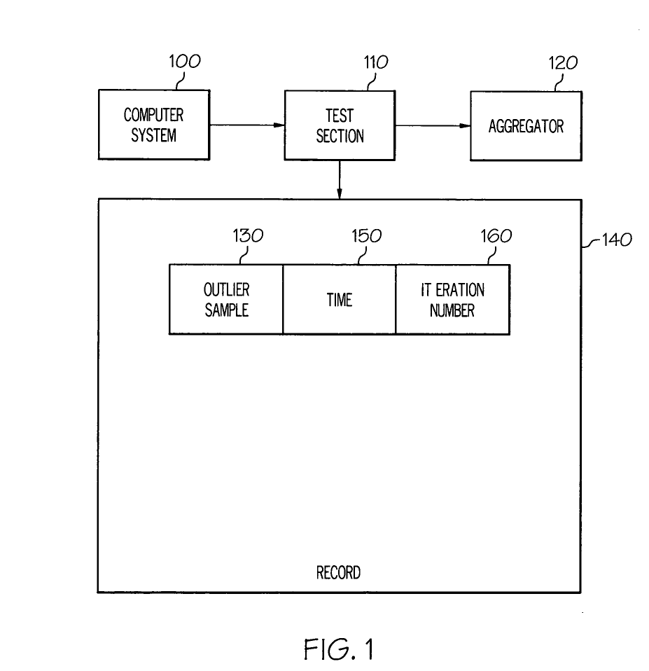

One system and method for statistical aggregation and posthumous inclusion of extreme data incorporating the present invention will now be described, by way of example only, with reference to the accompanying drawing, in which FIG. 1 shows a block schematic diagram illustrating a system and method for aggregation and posthumous inclusion of extreme data representative of message queueing response times.

### DETAILED DESCRIPTION

Briefly stated, the purpose of the novel scheme described below is to apply an aggregation technique to samples collected by a computer system and retain samples that are judged to be extreme, i.e., to lie outside the defined boundaries. The scheme enables an informed decision to be taken on whether to aggregate earlier outliers when samples are collected that are even more extreme.

The scheme takes the standpoint that just because a sample falls outside the boundaries, it does not predicate that the sample should be either discarded and therefore lost from future calculations, or incorporated into the aggregation summary and lost as a single entity. By not taking an informed view of an ‘outlier’ as in the prior art, the nature of its existence is discounted: if the outlier were arbitrarily incorporated into the aggregation summary its singularity would be lost and its effect on the aggregation summary would be diminished. In its preferred embodiment described more fully below, the scheme records the time and iteration point of the outlier sample, allowing an informed decision to be taken on aggregation/non-aggregation. The basis of this decision is discussed below.

The existence of a single outlier from thousands of collected and aggregated samples is lost by standard aggregation techniques, but may imply a problem with the system under study that has generated the outlier during an extreme event. Furthermore, such an outlier may be expected, but, for example, only during a particular time of day or at a particular frequency of samples. Understanding the exact nature of an outlier allows a differentiation against outliers that occur at a time of day or at a frequency that is not anticipated and may considered as contrary to ‘business as usual’.

Referring now to FIG. 1, data samples from a computer system 100 are tested in a test section 110 to determine whether a data sample falls within or outside a statistical normal distribution. A statistical normal distribution is initially chosen for aggregating the collected samples. After a particular time, the samples collected are judged to be representative of the sample population. From that point forward, samples that fall outside of the ‘boundaries’ derived from the statistical distribution are deemed to be outliers. A sample which is determined not to be an outlier is used for aggregating into an aggregation summary in an aggregator 120, in a well known manner.

An ‘outlier’ sample 130 is recorded as an entry in record 140, marked with two related parameter identifiers:
1. the time (150) the sample was collected, which may be related back to the start of the test, or related to the specific time of day; and
2. the iteration number (160) of the sample collected, which amy be related back to the number of samples already collected. It will be understood that as used herein the iteration number is the ordinal number of the sample in a sequence of samples.

It will be understood that this novel scheme allows for an informed decision to be taken on how to treat an outlier sample.

The statistical average is used to determine whether a sample lies outside of a given statistical distribution, i.e., is an outlier sample. The amplitude of the sample is not of interest in this scheme (and is already covered by prior art, as is well known). Rather, in this novel scheme, it is the periodicity of outlier samples, e.g., the time of day at which they occur, and the subsequent analysis afforded by these observations, that provide the main value of this novel scheme. It will be appreciated that unlike prior art schemes which involve the allocation of samples of different amplitudes into groups and in which it is presumed that different weightings can be applied to different groups, this novel scheme places all outlier samples into a single group, that can then used as input to an analysis technique such as Fourier analysis to determine which outliers are expected, and which are unexpected.

It is anticipated that some samples will be outliers, and it is not necessarily intended (although it is possible) to use these samples to calculate a more accurate average for the whole data set. It is anticipated that these samples will often follow a repeating and well understood pattern. Analyzing the outlier data, in the absence of the samples which fall inside the bounds of a given statistical distribution, can now reveal both expected outliers (usual ‘unusual samples’) and unexpected outliers (unusual ‘unusual samples’). Although this behavior could be detected by painstaking analysis of every data point collected and plotted on a chart as is true of other sample aggregation techniques known in this field, the advantage of this novel scheme its ability to allow automated data collection and performance of automatic analysis by computer with the explicit intention of generating warnings for unexpected outliers only (as opposed to expected outliers).

Although not required, if desired the outlier samples may be subsequently aggregated into the aggregation summary, dependent on the related parameter identifiers, e.g., only ‘expected’ outliers may be aggregated into the summary. It will, of course, be understood that if outlier samples are subsequently aggregated into the aggregation summary, those outlier samples should also be retained separately from the summary in order to enable those outlier samples to be used for further statistical analysis.

A practical application of this novel scheme can be illustrated by applying the idea to collecting response times for a special event.

For example, for a business customer using IBM's WebSphere™ message queueing system, the response time of putting a message to, or getting a message from, a queue can be measured throughout a working day. There will be particular times of day at which a degradation in response is expected, such as the start and end of office hours, or lunchtime, and particular frequencies, such as the rate of putting and getting messages in a ‘Websphere MQ’™ system, e.g., every interval—predetermined time period or predetermined number of operations—that a system management task occurs.

Some samples are determined to be outside the boundaries according to the aggregation technique applied to the collected samples. The aggregation summary is not of direct interest at this point. However, the identifiers of the outlier samples, e.g., time of occurrence and iteration point are examined to decide whether the outlier is expected, or unexpected. The strength of the approach offered by this novel scheme is that unexpected degradations can be detected and investigated because the singularity of the outlier is maintained without being aggregated into the summary, and a decision can be made on whether to discard the outlier such that it purposely does not perturb the summary or whether to include the outlier in the summary so that samples at the extremes are more likely to be ‘normal’ occurrences in future. Should the response time sample be particularly shorter or longer than the aggregated value, it may be decided to discard the sample in order to maintain an untainted aggregate value (i.e., if the sample were to be aggregated it would extend the boundaries), or it may be decided to include the sample because it is a fair sample of degraded system performance, and needs equal representation in the aggregation summary. A particularly long sample time can even be compared to the existing outliers to determine whether its frequency of occurrence is in line or out of line with the current set of outliers.

In this way, a messaging application may be designed to perform specific tasks either after a certain period of time, or after a certain number of transactions. If the performance of the application is measured, slow performance is expected when these special tasks are executed. Now, if slow performance occurs at an unexpected number of transactions or at an unexpected time interval, there could be a problem with the application, or a behavior that is not understood, and a more detailed analysis at these times can be undertaken.

Other examples of application of this novel scheme include, without limitation, the response time of a web page on the Internet, or the round trip time of an automated teller machine (ATM).

In the case of application of this novel technique to an Internet web page, the response time of a web site may be approximately constant through the business day, except for slower response times when the web site is more heavily loaded at the beginning of the business day, at lunchtime, and at the end of the business day, all of which are expected. Now if, for instance, web site resources are consumed by another part of the corporation, this will impact the performance of the web site, but possibly still fall within the limits of expected behavior, say for the lunchtime period. However, because there can now be a differentiation between expected and unexpected outliers, it is possible to issue a warning that the slow behavior is happening at an unexpected time of day. If there is a slow response over lunch, no action need be taken, but if abnormal behavior occurs in the middle of the afternoon, it is appropriate to intervene, perhaps examining the system more closely at such times.

It will be appreciated that the novel scheme described above may be carried out in software running on a processor in one or more computers, and that the software may be provided as a computer program element carried on any suitable data carrier such as a magnetic or optical computer disc.

It will be understood that the system and method for statistical aggregation and posthumous inclusion of extreme data described above provides the advantage of allowing differentiation between outliers and enables an informed decision to be taken on whether to aggregate earlier outliers when samples are collected that are even more extreme.

1. A system for statistical aggregation of data, comprising:
means for analyzing a data sample to determine whether the data sample lies within or outside a predetermined range;
means for aggregating the data sample into a summary if the data sample is determined to lie within the predetermined range; and
means for recording the data sample, together with at least one related parameter, if the data sample is determined to lie outside the predetermined range.

2. The system according to claim 1, wherein the at least one related parameter comprises an indication of the time at which the data sample was taken.

3. The system according to claim 1, wherein the at least one related parameter comprises an indication of the data sample's iteration number.

4. The system according to claim 1, further comprising means for analyzing the at least one related parameter and in dependence thereon aggregating the recorded data sample into the summary.

5. The system of claim 1, wherein the data sample is representative of response time of a predetermined event.

6. The system of claim 5, wherein the data sample is representative of one of: response time of putting a message to a message queue, response time of getting a message from a message queue, response time of an internet web page, and round trip time of an automated teller machine.

7. A method of statistical aggregation of data, comprising:
analyzing a data sample to determine whether the data sample lies within or outside a predetermined range;
aggregating the data sample into a summary if the data sample is determined to lie within the predetermined range; and
recording the data sample, together with at least one related parameter, if the data sample is determined to lie outside the predetermined range.

8. The method according to claim 7, wherein the at least one related parameter comprises an indication of the time at which the data sample was taken.

9. The method according to claim 7, wherein the at least one related parameter comprises an indication of the data sample's iteration number.

10. The method according to claim 7, further comprising analyzing the at least one related parameter and in dependence thereon aggregating the recorded data sample into the summary.

11. The method of claim 7, wherein the data sample is representative of response time of a predetermined event.

12. The method of claim 11, wherein the data sample is representative of one of:
response time of putting a message to a message queue, response time of getting a message from a message queue, response time of an internet web page, and round trip time of an automated teller machine.

13. A computer program product for statistical aggregation of data, the computer program product comprising a computer readable medium having computer readable program code tangibly embedded therein, the computer readable program code comprising:
computer readable program code configured to analyze a data sample to determine whether the data sample lies within or outside a predetermined range;
computer readable program code configured to aggregate the data sample into a summary if the data sample is determined to lie within the predetermined range; and
computer readable program code configured to record the data sample, together with at least one related parameter, if the data sample is determined to lie outside the predetermined range.

14. The computer program product according to claim 13, wherein the at least one related parameter comprises an indication of the time at which the data sample was taken.

15. The computer program product according to claim 13, wherein the at least one related parameter comprises an indication of the data sample's iteration number.

16. The computer program product according to claim 13, further comprising computer readable program code configured to analyze the at least one related parameter and in dependence thereon aggregate the recorded data sample into the summary.

17. The computer program product of claim 13, wherein the data sample is representative of response time of a predetermined event.

18. The computer program product of claim 17, wherein the data sample is representative of one of: response time of putting a message to a message queue, response time of getting a message from a message queue, response time of an internet web page, and round trip time of an automated teller machine.
